(19) United States
(12) Patent Application Publication
(10) Pub. No.: US 2006/0021426 A1
(43) Pub. Date: Feb. 2, 2006

(54) Pressure sensor on tyre valve

(75) Inventor: Didier Pozzi, Taverny (FR)

Correspondence Address: FOLEY & LARDNER LLP, 777 EAST WISCONSIN AVENUE, SUITE 3800, MILWAUKEE, WI, 53202-5308, US

(73) Assignee: Johnson Controls Automotive Electronics

(21) Appl. No.: 10/514,346

(22) PCT Filed: May 12, 2003
(86) PCT No.: PCT/FR03/01438

§ 371 Date: Jul. 21, 2005

(30) Foreign Application Priority Data
May 15, 2002 (FR) 02/05960

(51) Int. Cl. B60C 23/02

(52) U.S. Cl. 73/146.8

(57) ABSTRACT

The invention relates to a pressure measuring module for a tyre (10) comprising an air pressure sensor (50) with an air inlet (51), an intermediate base (40) and a valve (30). It is characterised by the fact that the pressure sensor is mounted laterally with respect to the axis of the valve. In particular, the air inlet of the sensor is turned radially towards the outside of the rim and the pressure sensor is exposed to the flow of air (81) passing through the valve (30) causing negative pressure at the air inlet (51). The invention makes it possible to avoid dirt from being deposited in the air inlet of the sensor.

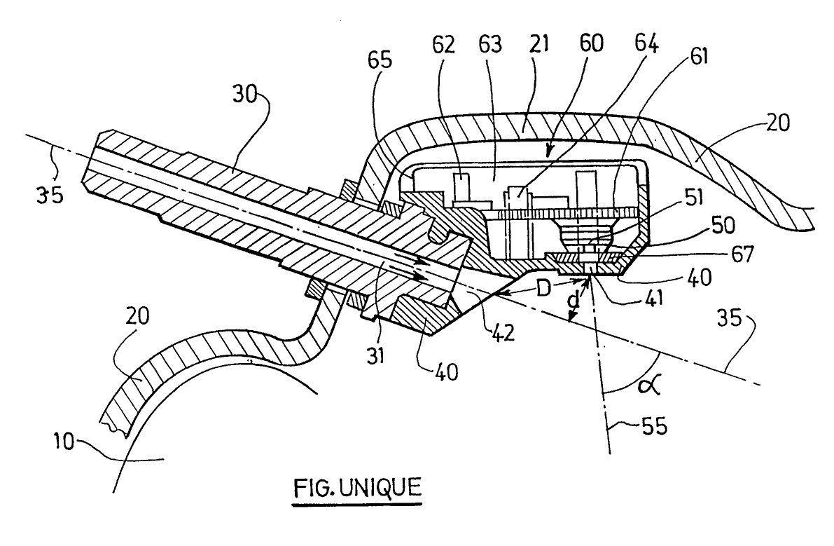

### CROSS REFERENCE TO RELATED APPLICATIONS

This application is a National Stage of Application PCT/FR03/01438, filed May 12, 2003, and claims priority to French patent application 02 05 960 filed May 15, 2002, the disclosures of which are incorporated herein by reference in their entirety.

### BACKGROUND

The invention relates to a module for measuring tire pressure, used in particular to measure the pressure of the air inside an automobile vehicle tire in order to signal to the driver that the tire is in a condition of deflation or over-inflation.

Pressure measuring modules is are generally fixed on the rim of a tire and comprise, within a housing, a pressure sensor with an air inlet, a printed circuit board on which the sensor is mounted and a communication duct between the air inlet of the sensor and the inside of the tire, all these elements being embedded in a coating resin.

The document FR 2 787 187 describes an assembly of this type. This also includes pressure measuring sensors in the form of an assembly which is screwed on the end of a valve and forms therewith an assembly with mechanical cylindrical symmetry. The document U.S. Pat. No. 4,734,674 describes an assembly of this type.

The pressure measuring module in a tire tends to be exposed to environmental attack caused by rain, soap, dust, carbon particles and especially anti-puncture products. All these agents may pollute or even block the air inlet of the pressure sensor and consequently render the sensor inoperative.

In order to avoid these disadvantages and others owing to the pressure measuring operation itself, the solutions generally proposed consist of interposing an air filter or an equivalent device in the air inlet of the pressure sensor. This is particularly the case with the devices proposed in the two documents mentioned above.

However, these devices as designed either necessitate specialized tooling to mount or remove the pressure measuring module or lead to a complex mechanism having to be produced in order to integrate the processing and transmission electronics therein. This means that, in summary, they necessitate costs which would be preferable to avoid.

### SUMMARY

One embodiment is directed to a tire pressure measuring module comprising an air pressure sensor with an air inlet, an intermediate base and a valve, the pressure sensor being mounted laterally with respect to the axis of the valve. The air inlet of the sensor is turned radially towards the outside of the rim.

Another embodiment relates to a tire pressure measuring module where when the tire is inflated the flow of air drives impurities from the air inlet of the sensor.

Another embodiment is directed to a tire pressure measuring module where the module is configured such that the air inlet of the pressure sensor is exposed to the flow of air passing through the valve.

### BRIEF DESCRIPTION OF THE DRAWING

The invention will be better understood with the aid of the following description of a preferred embodiment thereof with reference to the attached drawing showing a cross-sectional view of the pressure measuring module and its base which are mounted on the valve.

### DESCRIPTION OF THE EXEMPLARY EMBODIMENTS

The the exemplary embodiment aims to simplify the assembly of the pressure measuring module while attempting to maintain operation is equivalent to that previously obtained, in particular with respect to the protection of the air inlet of the pressure sensor against impurities polluting the internal atmosphere of the tire.

To this end the exemplary embodiment relates to a tire pressure measuring module comprising an air pressure sensor with an air inlet, an intermediate base and a valve, the pressure sensor being mounted laterally with respect to the axis of the valve and characterised by the fact that the air inlet of the sensor is turned radially towards the outside of the rim.

The air inlet of the pressure sensor is preferably exposed to the flow of air passing through the valve.

Thus each time the tire is inflated the flow of air may tend to drive the impurities from the air inlet of the sensor.

The base is advantageously pierced by an opening, channeling the flow of air exiting the valve in order to cause negative pressure at the air inlet.

An optimal effect is may be obtained when the axis of the air inlet of the sensor and the axis of the valve are substantially coplanar and form an angle of approximately 22° between them.

All these factors may contribute to keeping the air inlet of the pressure sensor free of any impurity without having to remove it.

The module is preferably protected by a housing which forms with the base an assembly arranged to conform to the surface of the groove in the rim and in the proximity of the placement of the valve. By means of this arrangement the air inlet of the sensor may be turned radially towards the outside of the wheel. Centrifugal force in itself may prevent any deposit on the air inlet.

The pressure measuring module 60 has an electronic board 61 as a support for electronic components such as 62, a pressure sensor 50 with the air inlet 51 which permits the ambient pressure to be measured by the sensor. The board and the sensor are housed in a housing 65 which is extended by a base 40 by which it is fixedly attached to a valve 30. The valve is mounted on the rim 20 which bears the tire (10).

The housing, the base and the module are assembled mechanically, for example by means of a spindle 64 fixedly attached to the base, on which the board and the housing are screwed. The assembly is sealed and filled with resin 63 serving as an insulator and improving the behavior during vibration.

The pressure sensor 50 is placed on the electronic board 61 in such a way that its air inlet 51 is located facing an opening 41 provided in the base 40. A gasket 67 has been inserted between the sensor and the base in order to protect the air inlet and the opening from any stray deposit of resin during manufacture.

In accordance with another embodiment, not illustrated, an air filter is placed across the inlet to protect it from any soiling which may occur.

In accordance with a particular embodiment the intermediate base 40 is made of polyamide, for example PA66, and is over-molded on the valve 30. As shown in the FIGURE it is disposed laterally with respect to the axis 35 of the valve so as to allow the flow of air 31 to discharge freely in this direction.

The valve thus serves as a support for the pressure sensor and for its board. The assembly can be removed or remounted simply by removing or remounting the valve.

The base is also arranged to directly expose the air inlet 41, 51 of the pressure sensor 50 to the flow of air 31 during inflation of the tire. For this purpose the axis 35 of the valve and the axis 55 of the air inlet 41, 51 are substantially in the same plane and form between them an angle α which is experimentally determined, for example α=22° 30′. The distances d from the air inlet 41 to the axis 35 and D separating the air inlet 41 and the opening 42 are minimal, the ratio D/d also being determined experimentally. Finally, the shape f of the opening 42 provided in the base 40 is also determined in order to guide the flow of air in the direction of the air inlet of the sensor.

The shape of the housing 65 conforms to the surface 21 of the groove in the rim.

This arrangement permits the air inlet of the pressure sensor to be orientated so as to take advantage of centrifugal force and to eject impurities therefrom.

In this same way this arrangement is used when stationary during cleaning of the air inlet: the wheel is positioned with the valve at the top and the tire is deflated and re-inflated. The dirt which has been driven out by the flow of air cannot re-obstruct the air inlet at the end of the inflation procedure.

1. A pressure measuring module for a tire having a rim, the module comprising:
an air pressure sensor with an air inlet,
an intermediate base, and
a valve, the pressure sensor being mounted laterally with respect to the axis of the valve,
wherein the air inlet of the sensor is turned radially towards an outside of the rim.

2. Module as claimed in claim 1, further comprising a housing coupled to the base and forming an assembly arranged to conform to the surface of the groove in the rim and in the proximity of the placement of the valve.

3. Module as claimed in claim 1, wherein the pressure sensor is exposed to the flow of air passing through the valve.

4. Module as claimed in claim 1, wherein the base is provided with an opening arranged to channel a flow of air exiting the valve and to cause negative pressure at the air inlet.

5. Module as claimed in claim 1, wherein an axis of the air inlet of the sensor and an axis of the valve are substantially coplanar and form an angle of approximately 22° between them.

6. Module as claimed in claim 1, wherein the base is over-moulded on the valve.

7. Module as claimed in claim 1, wherein the pressure sensor comprises a filter.

8. A pressure measuring module for a tire comprising:
an air pressure sensor having an air inlet, and
a valve;
wherein the pressure sensor is exposed to the flow of air passing through the valve.

9. The module of claim 8, wherein the module is configured such that a flow of air exiting the valve causes negative pressure at the air inlet.

10. The module of claim 8, further comprising a base coupled to the pressure sensor and over-molded on the valve.

11. The module of claim 8, wherein the air inlet of the sensor is turned radially towards an outside of a tire rim of the tire.

12. The module of claim 8, wherein an axis of the valve and an axis of the air inlet are substantially coplanar.

13. The module of claim 8, wherein an axis of the valve and an axis of the air inlet form an angle of about 22°.

14. A pressure measuring module for a tire comprising:
an air pressure sensor having an air inlet, and
a valve;
wherein the pressure sensor and valve are coupled such that a flow of air exiting the valve causes negative pressure at the air inlet.

15. The module of claim 14, further comprising a base coupled to the pressure sensor and over-molded on the valve.

16. The module of claim 14, wherein the air inlet of the sensor is turned radially towards an outside of a tire rim of the tire.

17. The module of claim 14, further comprising a base coupled to the valve and the pressure sensor and having an opening near the valve that is configured to guide a flow of air in a direction of the air inlet.

18. The module of claim 14, wherein the air inlet is arranged such that centrifugal force of a rotation of the tire can aid in ejecting impurities from the air inlet.

19. The module of claim 14, wherein an axis of the valve and an axis of the air inlet are substantially coplanar.

20. The module of claim 14, wherein an axis of the valve and an axis of the air inlet form an angle of about 22°.
